(19) United States
(12) Patent Application Publication
(10) Pub. No.: US 2003/0182632 A1
(43) Pub. Date: Sep. 25, 2003

(54) System and method for remote localization service

(76) Inventors: Joseph Bert Murdock, Camas, WA (US); Tommy Lee Oswald, Tigard, OR (US)

Correspondence Address: David C. Ripma, Patent Counsel, Sharp Laboratories of America, Inc., 5750 NW Pacific Rim Boulevard, Camas, WA, 98607, US

(21) Appl. No.: 10/094,229

(22) Filed: Mar. 8, 2002

(51) Int. Cl. G06F 17/24

(52) U.S. Cl. 715/536

(57) ABSTRACT

A system and method are provided for remotely provisioning text string information in a network of connected devices. The method comprises: establishing a localization server loaded with text string information; accessing the localization server from a remote localization enabled (RLE) device; transferring text string information from the localization server to the RLE device; and, displaying the text string information to an RLE user. Accessing the localization server from a remote localization enabled (RLE) device includes selecting and requesting the first set of text string information. In some aspects of the method, the first set of text string information is selected in response to installing the RLE device. Then, the method further comprises: following the transferring of the first set of text string information, storing the first set of text string information in a RLE device permanent memory. In other aspects, the first set of text string information is selected in response to initializing the RLE device and the method further comprises: reiteratively storing the first set of text string information in a RLE device volatile memory in response to each initialization of the RLE device. In another aspect the method comprises: a user interacting with the RLE device initiates a request. Then, the first set of text string information is selected in response to the request, and text string information is iteratively transferred in response to each user-initiated request. Alternately, a plurality of text strings related to the first set of text string information is transferred and the method further comprises: selecting a set of text string information in response to the subsequent request from the transferred plurality of text strings.

### BACKGROUND OF THE INVENTION

1. Field of the Invention

This invention generally relates to network communications and, more particularly, to a system and method for supplying localized text information to remote devices that are connected through a network.

2. Description of the Related Art

Embedded devices, such as multifunction peripherals (MFPs), are often configured with text strings, which are sequences of alpha-numeric characters. These characters are often presented on the MFP displays, for the purpose of conveying information in a human readable form. To be of benefit to an end user, text strings should be presented in a language that the end user understands. For example, if an MFP is sold in France, the presented text strings should be displayed in French. Furthermore, different languages can use different alphabets (character sets) in order to display a string. As such, a text string also needs to be encoded in a manner suitable for the language. For example, for an English message displayed in the United States, the text strings can be encoded in a US-ASCII character set, while the same string displayed in Russian would need to be encoded in a Cyrillic character set.

Conventionally, embedded devices intended for sale in multiple countries typically store multiples copies of each string within the embedded device's non-volatile memory, along with the appropriate character set look-up tables. The look-up table is required to support multiple languages. However, this solution typically consumes unnecessary memory (unused languages are stored in memory), is not extensible (additional languages can not be added), and is difficult to update.

It would be advantageous if remotely located embedded devices could be supplied with text string information in the appropriate language and character sets, when required.

It would be advantageous if the remotely located embedded devices had access to text string information in a plurality of languages and character sets, without wasting memory on unused languages and character sets.

### SUMMARY OF THE INVENTION

This present invention is different from the conventional devices in that the localized character strings need not be permanently stored, instead the character strings can be stored on an external server. The advantage to storing the character strings on an external server include:

1) The device need only store the languages and character sets that are in use at its physical location. For example, if the device is located in France, only French text strings need to be stored in the device, thereby reducing memory consumption for string storage;

2) The device does not need to store strings at all but can retrieve individual text strings from a server on an as-needed basis;

3) Strings can be updated at will. These updates can easily be made to all network-connected devices;

4) A device can be shipped without any regard to localization issues and can be localized onsite, or according to the users preference;

5) Additional language support can be easily added; and,

6) The device messages can be easily customized according to the user's preference.

Accordingly, a method is provided for remotely provisioning text string information in a network of connected devices. The method comprises: establishing a localization server loaded with text string information; accessing the localization server from a remote localization enabled (RLE) device; transferring text string information from the localization server to the RLE device; and, displaying the text string information to an RLE user.

Accessing the localization server from a remote localization enabled device includes selecting and requesting the first set of text string information. In some aspects of the method, the first set of text string information is selected in response to installing the RLE device. Then, the method further comprises: following the transferring of the first set of text string information, storing the first set of text string information in a RLE device permanent memory. In other aspects, the first set of text string information is selected in response to initializing the RLE device and the method further comprises: reiteratively storing the first set of text string information in a RLE device volatile memory in response to each initialization of the RLE device.

In another aspect the method comprises: a user interacting with the RLE device initiates a request. Then, the first set of text string information is selected in response to the request, and text string information is iteratively transferred in response to each user-initiated request. Alternately, a plurality of text strings related to the first set of text string information is transferred and the method further comprises: selecting a set of text string information in response to the subsequent request from the transferred plurality of text strings.

Establishing a localization server loaded with text string information includes loading the localization server with text strings in a plurality of languages and character sets. Then, selecting a first set of text string information includes selecting a text string language and character set.

Additional details of the above-described method and a system for remotely provisioning text string information are provided below.

### BRIEF DESCRIPTION OF THE DRAWINGS

FIG. 1 is a schematic block diagram illustrating the present invention system for remotely provisioning text string information.

FIG. 2 illustrates the process followed by an RLE device connecting to a localization service to receive a message, once in US English, and once in French.

FIG. 3 is a flowchart illustrating the present invention method for remotely provisioning text string information in a network of connected devices.

### DETAILED DESCRIPTION OF THE PREFERRED EMBODIMENTS

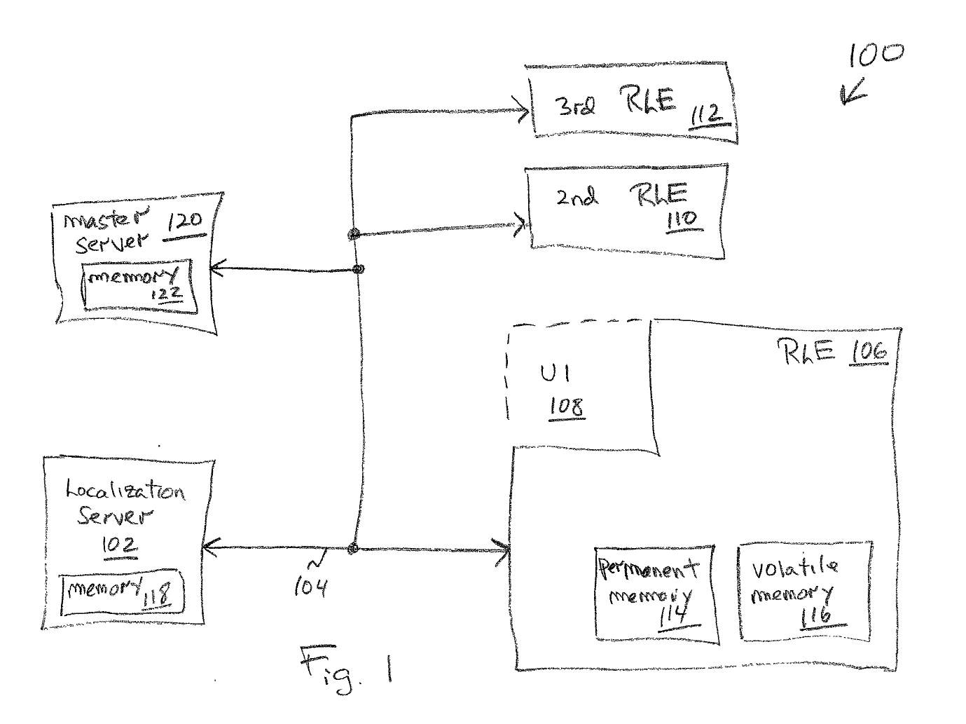

FIG. 1 is a schematic block diagram illustrating the present invention system for remotely provisioning text string information. The system 100 comprises a localization server 102 having a network-connected port on line 104 to supply text string information. Line 104 represents a network or a combination of networks, such as plain old telephone service (POTS) or a local area network (LAN) to name but a couple of examples. The present invention system 100 is not limited to any particular network or connection medium. At least one remote localization enabled (RLE) device 106 has a network-connected port for accessing the localization server 102 and accepting the transfer of text string information.

Typically, the RLE device 106 accepts transfers of text string information in a format such as XML or HTML protocols. However, the present invention system is not limited to any particular protocol. The RLE device 106 can be a device such a multifunction peripheral (MFP), a consumer entertainment appliance, a television, a television set top box, a VCR, a DVD, a video games, or a smart kitchen appliances such as a microwave, oven, or refrigerator.

A user interface 108 is connected to the RLE device 106 to display the transferred text string. The user interface 108 can be an integral part of the RLE in some aspects. For example, the user interface can be a front panel on a RLE MFP. As an alternate example, the user interface can be a personal computer (PC) connected to the RLE MFP. Also shown are a second RLE 110 and a third RLE 112, however, the present invention system is not limited to any particular number of RLE devices.

The basic operation of the system 100 involves the RLE device 106 selecting a first set of text string information, which can be a single text string or a set of text strings. The RLE device 106 requests the first set of text string information from the localization server 102 and accepts the transfer of the first set of text string information. In some aspects of the system, the RLE device 106 selects a first set of text string information in response to the RLE device 106 being installed in the network 104. For example, as part of the initial network connection, the administrator may be required to make some selections with regard to language or character sets. Alternately, these selection can be a RLE default setting. Following the transferring of the first set of text string information, The RLE device 106 stores the first set of text string information in a RLE device permanent memory 114.

In some aspects of the system 100, the RLE device 106 selects a first set of text string information in response to the RLE device 106 being initialized. Initialization is the process of powering on the device. For example, initialization can be an event that occurs on a daily basis, or an event that occurs after a maintenance operation or a power interruption. Following the transferring of the first set of text string information, the RLE device 106 reiteratively stores the first set of text string information in a RLE device volatile memory 116 in response to each initialization of the RLE device 106. Alternately stated, the text string information is not stored in permanent memory 114.

In some aspects, the RLE-connected user interface (UI) 108 has an input to accept user requests. For example the UI 108 can include a keypad, touchscreen, keyboard, mouse, or voice recognition system. The RLE device 106 selects a first set of text string information in response to the user request, and accepts transfers of text string information from the localization server 102 iteratively, in response to each user-initiated request. For example, the user requests help on a device function. Perhaps the request includes the selection of a particular language. In a different aspect, the RLE device 106 selects a first set of text string information in response to the request, and accepts transfers of a plurality of text strings related to the first set of text string information. Then in response to subsequent user-initiated requests, the RLE 106 selects text string information from the plurality of transferred text strings. That is, in response to a request for help on a particular device function, text string help menus for all device function are downloaded.

Typically, the localization server 102 has a memory 118 loaded with a first plurality of text strings in a second plurality of languages. The RLE device 106 accepts text string information in response to selecting a text string language. Likewise, the localization server memory 118 can be loaded with a first plurality of text string in a third plurality of character sets, and the RLE device 106 accepts text string information in response to selecting a character set. These transferred text strings are stored in either permanent memory 114 or volatile memory 116. In some aspects of the system 100, the above-mentioned selections are made in response to a user-initiated request, using the UI 108. For example, a French-speaking user operating a RLE device in the US may initiate a request to download text strings in the French language. Likewise, user-initiated requests can be initiated for selected character sets.

In some aspects of the system 100, the localization server memory 118 is loaded with text string information cross-referenced to device manufacturers and model numbers. Then, the RLE device 106 accepts text string information in response to selecting a device manufacturer and model number. For example, particular character strings in the localization server memory 118 may be tailored to correspond with manufacturer-specific devices features. Likewise, localization server memory 118 can be loaded with text string information cross-referenced to accessing clients, and the RLE device accepts text string information in response to establishing client identification. The client information may be used for billing purposes or to identify particular text strings that are associated with corresponding clients.

Some aspects of the system further comprise a master server 120 having a memory 122 loaded with a master set of text string information and a network-connected port on line 104 to supply text string information. In this scenario the localization server memory 118 may only include a partial set of text string information. Then, prior to requesting specific text string information, the RLE device 106 accesses the localization server 102 to determine if the localization server 102 is loaded with the selected text string information. For example, a request could be made to determine the languages and/or character sets that are supported by the localization server 102. If the localization server 102 is not loaded with the selected text string information, the RLE device 106 can access the master server, after requesting a list of supporting servers. For example, before requesting a text string in French, the RLE device 106 may access the localization server 102 to determine if French is among the languages supported by the server. Note that is some aspects of the system 100, the master and localization servers are the same server. It should also be noted that the system 100 is not limited to any particular number of master or localization servers.

Some aspects of the system 100 further comprise a network message protocol including an “open connection” message from the RLE device to identify criteria such as localization server identity, client identification, RLE device manufacturer and model number information, and a security code to authenticate the client identification. The network message protocol also includes a “close connection” message from the RLE device to terminate communications with the localization server.

The network message protocol includes a “connection closed” message from the RLE device to acknowledge the termination of communications with the RLE device. A “retrieve” message from the RLE device is used to identify criteria such as text strings, text string languages, and character sets. The network message protocol also includes a “get languages” message from the RLE device to request a list of supported languages, a “get character sets” message from the RLE device to request a list of supported character sets, and a “get servers” message from the RLE device to request a list of accessible servers.

### Functional Description

The present invention system consists of three primary entities: a remote localization enabled (RLE) device that has been designed to take advantage of remote localization, a localization server, and the remote localization service (RLS), which is a software process that enables the system. In one aspect, the software executes in the localization server. Alternately, the execution occurs in the RLE or in both the localization server and RLE.

The present invention system provides a method whereby an RLE device can send a request to an external localization server, requesting a character string in a specific language and character set, for a specific product from a specific company. The request specifies a string identifier (key), a requested language, and a requested character set. The request also includes a connection identifier, returned by the remote localization service, from a connection request for a localization session for a specific product and company. The localization server responds with the appropriate character string, or indicates if the requested language or character set is unavailable. The invention can be enabled using a variety of text string database internal organization schemes. Typically however, the present invention system organizes the text string database as a sequential array of strings, each accessible by a single index number and language/character set identifier. Placing no internal database organization requirements on the RLS allows for the sharing of common text strings, with the caveat that a single product text string database be seen, by the product, as a sequential series of strings.

The use of a centralized localization server approach permits varied means of implementation as follows:

1) Localization servers can be distributed throughout the world. Each server would contain the languages and character sets most likely to be used within the geographic locality of the server. A localization server could provide localized strings requiring languages or character sets not available on the server by forwarding the request to a different localization server. A master localization server, located at a well-known address would be maintained to provide a global access point for all RLE devices and other Localization Servers. Until configured otherwise (intended to be performed as part of product installation and configuration), an RLE device would be able to access the master localization server.

2) Custom localization servers can be deployed at large customer sites. This enables large customers to control network access for their RLE devices. Additionally, a local remote localization service could be modified to provide custom messages.

3) To reduce manufacturing costs and complexity, RLE devices could be shipped with the minimal text required to support product installation and contain no localized strings at all. A default language or languages would be specified during device installation or configuration, at which time the RLE device would obtain the complete set of text strings required for that product, the selected languages and the required character sets. These localized strings could then be either stored in the device's flash memory, or stored in the device's volatile RAM. Then, the download process could be repeated whenever the device in powered up, significantly reducing the need for flash memory. For example, if a printer is sent to Germany, it could be installed to download and store German and French on the printer for speedy access, but other languages such as Greek would be accessed directly from the localization server on an as needed basis for each interaction requiring Greek.

The localization server operates using a variety of network message protocols as explained in more detail below:

LocalizationServiceOpenConnection (server, companyID, productID, authenticationInfo)

This function (message) allows a RLE device to connect to a localization server. If no server is specified, the function attempts to connect to a default master server. The provided companyID and productID allow the use of a single localization server to provide localization services for multiple products and companies, providing a potential fee based service capability. Values used for companyID and productID are implementation dependant. The use of authenticationInfo is necessary to support copyright protection, service billing, and other issues associated with providing information for multiple companies and products. The function also provides a LocalizationServiceConnectionID, which must be provided with any further localization transactions. The LocalizationServiceConnectionID provides a means to verify the authenticity and validity of localization transactions, and provide a handle to any billing information that may be required. Since the LocalizationServiceConnectionID is created based on company and product specifications, it also effectively limits the scope of information returned.

LocalizationServiceCloseConnection (LocalizationServiceConnectionID)

This function allows a device to disconnect from a localization server. Once a localization service connection has been closed, any billing and use tracking information obtained during the connections duration can be used to update a local, regional or global localization service accounting system.

LocalizationServiceConnectionClosed (LocalizationServiceConnectionID)

This function serves both as the localization service's notification of (abnormal) connection termination and as acknowledgement of successful processing of LocalizationServiceCloseConnection.

LocalizationServiceRetreiveMessage (LocalizationServiceConnectionID, msgList, msgLanguage, MsgCharacterSet, msgNext)

This is the main functionality of the localization server. This function allows a RLE device to request one or more text strings (identified by a comma-delimited msgList) from the RLS (indicated in the LocalizationServiceConnectionID). Specifying zero (0) as the only argument for msgList indicates that all product messages are to be returned, in sequential order. This provides an RLE device with an easy method for retrieving a complete set of messages. Additionally, specifying a message list that consists of a single valid message ID followed by a message of 0 (zero), i.e. “7,0”, will cause the remote localization service to send a complete list of all messages from the specified message ID onward (i.e., all message after, and including, message number seven). The msgLanguage and msgCharacterSet specify the desired language and character set for encoding the message. Valid values for msgLanguage and msgCharacterSet are the same as those defined by the Internet Assigned Numbers Authority (IANA). The use of a NULL string for either value is not allowed. The RLS will respond with a comma-delimited list of message strings in the requested language and character set. In order to avoid conflicts between commas as string separators and commas within a string, the format of a text string being returned by an RLS is to be a two octet (16 bit) string length followed by the string itself. The localization server will also return a msgNextID indicator. If the request was for multiple messages and the localization server determines that the reply to a message request is too long to fit within a single reply, then the value of the msgNextID field will be the message ID of the next message to be retrieved, otherwise the value of msgNextID will be 0 (zero). This provides the RLE device with the information required to request the next series of messages.

LocalizationServiceGetLanguages (LocalizationServiceConnection ID)

Provides a method whereby the RLE device can query an RLS for a list of supported languages.

LocalizationServiceGetCharacterSets (LocalizationServiceConnect ionID )

Provides a method whereby the RLE device can query an RLS for a list of supported character sets.

LocalizationServiceGetServers (LocalizationServiceConnectionID)

Provides a method whereby the RLE device can query an RLS for a list of additional localization servers that support the company and product indicated by the LocalizationServiceConnectionID.

One example of the present invention system involves an RLE device having a requirement of delivering a HTML page. The RLE device sends a request containing all of the strings requiring localization for the HTML page to a localization server. After the localization server responds with the requested message(s), the RLE device renders the HTML page with the localized strings.

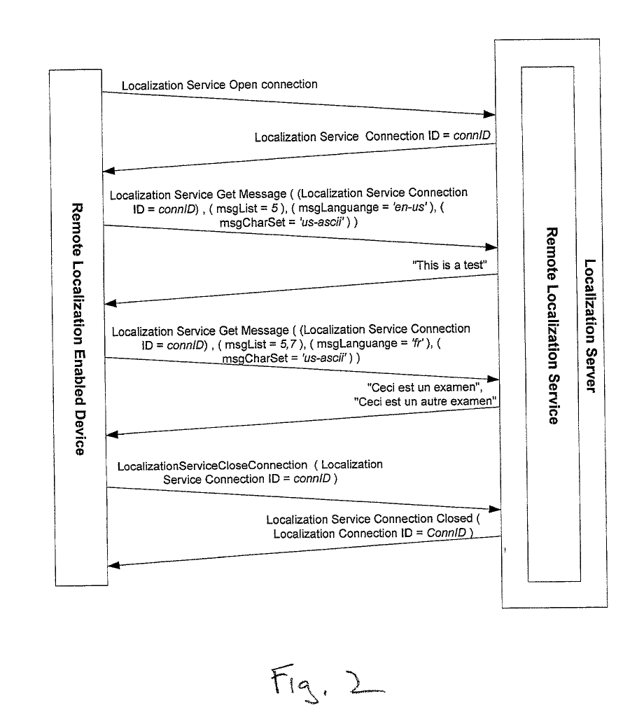

FIG. 2 illustrates the process followed by an RLE device connecting to a localization service to receive a message, once in US English, and once in French. The request for the French translation also includes a request for a second message.

To provide maximum portability between disparate systems, one aspect of the present invention system uses a series of XML actions, defined as the elements of a XML Schema, and accesses using a SOAP-like object access protocol. A partial template definition of the required minimal functionality is described below:

<actionList>

<action> <!-- open connection to Localization Service -->

<name>LocalizationServiceOpenConnection</name>
<argumentList>

<argument>

<name>server</name>
<direction>in</direction>

</argument>
<argument>

<name>companyID</name>
<direction>in</direction>

</argument>
<argument>

<name>productID</name>
<direction>in</direction>

</argument>
<argument>

<name>authenticationInfo</name>
<direction>in</direction>

</argument>
<argument>

<name>localizationServiceConnectionID</name>
<direction>out</direction>

</argument>

</argumentList>

</action>
<action><!-- close connection to Localization Service -->

<name>LocalizationServiceCloseConnection</name>
<argumentList>

<argument>

<name>LocalizationServiceConnectionID</name>
<direction>in</direction>

</argument>

</argumentList>

</action>
<action> <!-- inform RLE device that a connection was closed -->

<name>LocalizationServiceConnectionClosed</name>
<argumentList>

<argument>

<name>LocalizationServiceConnectionID</name>
<direction>in</direction>

</argument>

</arguementList>

</action>
<action> <!-- retrieve message(s) in specified language and charset

-->

<name>LocalizationServiceRetreiveMessage</name>
<argumentList>

<argument>

<name>LocalizationServiceConnectionID</name>
<direction>in</direction>

</argument>
<argument>

<name>msgList</name>
<direction>in</direction>

</argument>
<argument>

<name>msgLanguage</name>
<direction>in</direction>

</argument>
<argument>

<name>msgCharacterSet</name>
<direction>in</direction>

</argument>
<argument>

<name>msgText</name>
<direction>out</direction>

</argument>
<argument>

<name>msgNextID</name>
<direction>out</direction>

</argument>

</argumentList>

</action>
<action> <!-- get list of supported languages -->

<name>LocalizationServiceGetLanguages</name>
<argumentList>

<argument>

<name>LocalizationServiceAvailableLanguages</name>
<direction>out</direction>

</argument>

</argumentList>

</action>
<action> <!-- get list of supported character sets -->

<name>LocalizationServiceGetCharacterSets</name>
<argumentList>

</argument>

<name>LocalizationServiceAvailableCharacterSets</name>
<direction>out</direction>
</argument>

</arguementList>

<action>
<action> <!-- get list of supported character sets -->

<name>LocalizationServiceGetServers <name>
<argumentList>

<argument>

<name>LocalizationServiceAvailableServers</name>
<direction>out</direction>

</argument>

</arguementList>

<action>

</actionList>

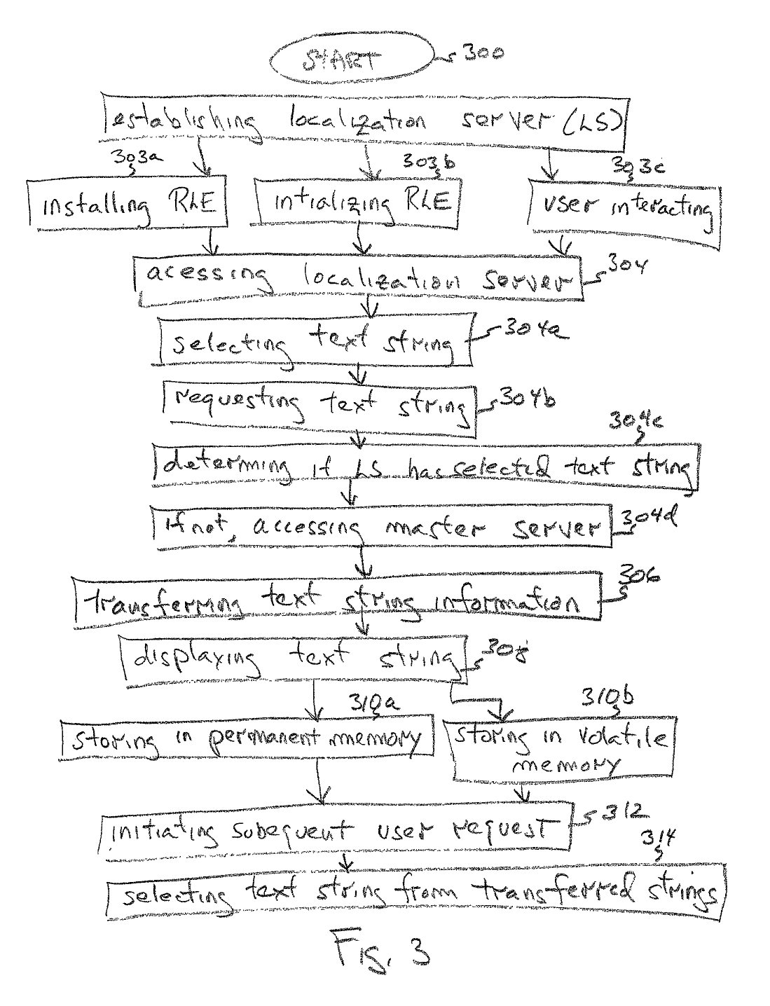

FIG. 3 is a flowchart illustrating the present invention method for remotely provisioning text string information in a network of connected devices. The method generally corresponds to FIGS. 1 and 2. Although this method is depicted as a sequence of numbered steps for clarity, no order should be inferred from the numbering unless explicitly stated. It should be understood that some of these steps may be skipped, performed in parallel, or performed without the requirement of maintaining a strict order of sequence. The methods start at Step 300. Step 302 establishes a localization server (LS) loaded with text string information. Step 304 accesses the localization server from a remote localization enabled (RLE) device. Accessing the localization server from a RLE device includes accessing from RLE devices such as multifunction peripherals (MFPs), consumer entertainment appliances, televisions, television set top boxes, VCRs, DVDs, video games, and kitchen appliances. Step 306 transfers text string information from the localization server to the RLE device. Step 308 displays the text string information to an RLE user.

Accessing the localization server from a remote localization enabled (RLE) device in Step 304 includes substeps. Step 304a selects a first set of text string information. Step 304b requests the first set of text string information. Then, transferring text string information from the localization server to the RLE device in Step 306 includes transferring the first set of text string information.

Some aspects of the method comprise a further step. Step 303a installs the RLE device in the network. Then, selecting a first set of text string information in Step 304a includes selecting a first set of text string information in response to installing the RLE device. Step 310a, following the transferring of the first set of text string information in Step 306, stores the first set of text string information in a RLE device permanent memory. Alternately, Step 303b initializes the RLE device, and selecting a first set of text string information in Step 304a includes selecting a first set of text string information in response to initializing the RLE device. Step 310b, following the transferring of the first set of text string information, reiteratively stores the first set of text string information in a RLE device volatile memory in response to each initialization of the RLE device.

Some aspects include an alternate step. In Step 303c a user interacting with the RLE device initiates a request. Then, selecting a first set of text string information in Step 304a includes selecting the first set of text string information in response to the request, and transferring text string information from the localization server to the RLE device in Step 306 includes iteratively transferring text string information in response to each user-initiated request. As another variation, transferring text string information from the localization server to the RLE device in Step 306 includes transferring a plurality of text strings related to the first set of text string information. In Step 312, following the first request, the user interacts with the RLE device to initiate a subsequent request. Step 314 selects a set of text string information in response to the subsequent request from the transferred plurality of text strings related to the first set of text string information.

In some aspects of the method, establishing a localization server loaded with text string information in Step 302 includes loading the localization server with a first plurality of text strings in a second plurality of languages. Then, selecting a first set of text string information in Step 304a includes selecting a text string language. Alternately, the localization server is loaded with a first plurality of text string in a third plurality of character sets and a character set is selected in Step 304a. In another variation, the text string language or character set is selected in Step 304a in response to installing the RLE device (Step 303a). Then, Step 306 transfers the first plurality of text strings in the selected language and Step 310a stores the first plurality of text strings in the selected language.

Likewise, the text string language or character set is selected in Step 304a in response to initializing the RLE device (Step 303b). Then, Step 306 transfers the first plurality of text strings in the selected language and Step 310b stores the first plurality of text strings in the selected language. Further, the text string language or character set is selected in Step 304a in response to a user-initiated request (Step 303c). Then, Step 306 transfers the first plurality of text strings in the selected language.

In some aspects, establishing a localization server loaded with text string information in Step 302 includes loading text string information cross-referenced to device manufacturers and model numbers. Then, accessing the localization server from a RLE device in Step 304 includes selecting a device manufacturer and model number. Likewise, the localization server can be loaded with text string information cross-referenced to accessing clients that are identified in Step 304, when the localization server is accessed from a RLE device.

In some aspects of the method, Step 302 establishes a server network including a master server loaded with a master set of text string information and at least a first localization server with a partial set of text string information. Then, accessing the localization server from a RLE device in Step 304 includes other substeps. Step 304c, prior to requesting the first set of text string information, determines if the first localization server is loaded with the selected text string information. Step 304d, if the first localization server is not loaded with the selected text string information, accesses the master server. Typically, Step 304c would be performed before any specific requests for text string information are made. The RLE must find a server with the proper information before the request is made. This is especially so if the RLE is initializing and large amounts of data are to be downloaded.

In some aspects, accessing the localization server from a RLE device in Step 304 includes communicating an “open connection” message from the RLE device to identify criteria such as localization server identity, client identification, RLE device manufacturer and model number information, and a security code to authenticate the client identification. In other aspects, accessing the localization server from a RLE device includes communicating a “close connection” message from the RLE device to terminate communications with the localization server.

In some aspects of the method, accessing the localization server from a RLE device includes communicating a “connection closed” message from the RLE device to acknowledge the termination of communications with the RLE device. Accessing the localization server from a RLE device includes communicating a “retrieve” message from the RLE device to identify criteria such as text strings, text string languages, and character sets. In other aspects, accessing the localization server from a RLE device includes communicating a “get languages” message from the RLE device to request a list of supported languages.

In some aspects, accessing the localization server from a RLE device in Step 304 includes communicating a “get character sets” message from the RLE device to request a list of supported character sets. In other aspects, accessing the localization server from a RLE device includes communicating a “get servers” message from the RLE device to request a list of accessible servers.

In some aspects of the method, transferring text string information from the localization server to the RLE device in Step 306 includes transferring the first set of text string information in a format such as XML or HTML protocols.

A system and method have been provided for remotely provisioning text string information. Examples have been given of the types of information that can be provisioned. Examples have also been given of some means of specifically enabling such provisioning. However, the invention is not limited to just these examples. Other variations and embodiments of the invention will occur to those skilled in the art.

We claim:

1. In a network of connected devices, a method for remotely provisioning text string information, the method comprising:
establishing a localization server loaded with text string information;
accessing the localization server from a remote localization enabled (RLE) device;
transferring text string information from the localization server to the RLE device; and,
displaying the text string information to an RLE user.

2. The method of claim 1 wherein accessing the localization server from a remote localization enabled (RLE) device includes:
selecting a first set of text string information;
requesting the first set of text string information; and,
wherein transferring text string information from the localization server to the RLE device includes transferring the first set of text string information.

3. The method of claim 2 further comprising:
installing the RLE device in the network;
wherein selecting a first set of text string information includes selecting a first set of text string information in response to installing the RLE device; and,
the method further comprising:
following the transferring of the first set of text string information, storing the first set of text string information in a RLE device permanent memory.

4. The method of claim 2 further comprising:
initializing the RLE device; and,
wherein selecting a first set of text string information includes selecting a first set of text string information in response to initializing the RLE device; and,
the method further comprising:
following the transferring of the first set of text string information, reiteratively storing the first set of text string information in a RLE device volatile memory in response to each initialization of the RLE device.

5. The method of claim 2 further comprising:
a user interacting with the RLE device to initiate a request;
wherein selecting a first set of text string information includes selecting the first set of text string information in response to the user-initiated request; and,
wherein transferring text string information from the localization server to the RLE device includes iteratively transferring text string information in response to each user-initiated request.

6. The method of claim 2 further comprising:
a user interacting with the RLE device to initiate a first request;
wherein selecting a first set of text string information includes selecting the first set of text string information in response to the first request;
wherein transferring text string information from the localization server to the RLE device includes transferring a plurality of text strings related to the first set of text string information; and,
the method further comprising:
following the first request, the user interacting with the RLE device to initiate a subsequent request; and,
selecting a set of text string information in response to the subsequent request from the transferred plurality of text strings related to the first set of text string information.

7. The method of claim 2 wherein establishing a localization server loaded with text string information includes loading the localization server with a first plurality of text strings in a second plurality of languages; and,
wherein selecting a first set of text string information includes selecting a text string language.

8. The method of claim 2 wherein establishing a localization server loaded with text string information includes loading the localization server with a first plurality of text string in a third plurality of character sets; and,
wherein selecting a first set of text string information includes selecting a character set.

9. The method of claim 3 wherein establishing a localization server loaded with text string information includes loading the localization server with a first plurality of text strings in a second plurality of languages; and,
wherein selecting a first set of text string information includes selecting a text string language in response to installing the RLE device;
wherein transferring text string information from the localization server to the RLE device includes transferring the first plurality of text strings in the selected language; and,
storing the first set of text string information in a RLE device permanent memory includes storing the first plurality of text strings in the selected language.

10. The method of claim 4 wherein establishing a localization server loaded with text string information includes loading the localization server with a first plurality of text strings in a second plurality of languages;
wherein selecting a first set of text string information includes selecting a text string language in response to initialing the RLE device;
wherein transferring text string information from the localization server to the RLE device includes transferring the first plurality of text strings in the selected language; and,
storing the first set of text string information in a RLE device volatile memory includes storing the first plurality of text strings in the selected language.

11. The method of claim 5 wherein establishing a localization server loaded with text string information includes loading the localization server with a first plurality of text strings in a second plurality of languages;
wherein the user interacting with the RLE device to initiate a request includes initiating a request in a first language;
wherein selecting the first set of text string information in response to the request includes selecting a text string in the first language; and,
wherein transferring text string information from the localization server to the RLE device includes transferring the selected text string in the first language.

12. The method of claim 6 wherein establishing a localization server loaded with text string information includes loading the localization server with a first plurality of text strings in a second plurality of languages;
wherein the user interacting with the RLE device to initiate a request includes initiating a request in a first language;
wherein selecting the first set of text string information in response to the request includes selecting a text string in the first language; and,
wherein transferring a plurality of text strings related to the first set of text string information includes transferring the first plurality of text strings in the first language.

13. The method of claim 2 wherein establishing a localization server loaded with text string information includes loading text string information cross-referenced to device manufacturers and model numbers; and,
wherein accessing the localization server from a RLE device includes selecting a device manufacturer and model number.

14. The method of claim 2 wherein establishing a localization server loaded with text string information includes loading text string information cross-referenced to accessing clients; and,
wherein accessing the localization server from a RLE device includes establishing client identification.

15. The method of claim 2 wherein establishing a localization server loaded with text string information includes establishing a server network including a master server loaded with a master set of text string information and at least a first localization server with a partial set of text string information; and,
wherein accessing the localization server from a RLE device includes:
prior to requesting the first set of text string information, determining if the first localization server is loaded with the selected text string information; and,
if the first localization server is not loaded with the selected text string information, accessing the master server.

16. The method of claim 2 wherein accessing the localization server from a RLE device includes communicating an “open connection” message from the RLE device to identify criteria selected from the group including localization server identity, client identification, RLE device manufacturer and model number information, and a security code to authenticate the client identification.

17. The method of claim 2 wherein accessing the localization server from a RLE device includes communicating a “close connection” message from the RLE device to terminate communications with the localization server.

18. The method of claim 2 wherein accessing the localization server from a RLE device includes communicating a “connection closed” message from the RLE device to acknowledge the termination of communications with the RLE device.

19. The method of claim 2 wherein accessing the localization server from a RLE device includes communicating a “retrieve” message from the RLE device to identify criteria selected from the group including text strings, text string languages, and character sets.

20. The method of claim 2 wherein accessing the localization server from a RLE device includes communicating a “get languages” message from the RLE device to request a list of supported languages.

21. The method of claim 2 wherein accessing the localization server from a RLE device includes communicating a “get character sets” message from the RLE device to request a list of supported character sets.

22. The method of claim 2 wherein accessing the localization server from a RLE device includes communicating a “get servers” message from the RLE device to request a list of accessible servers.

23. The method of claim 2 wherein transferring text string information from the localization server to the RLE device includes transferring the first set of text string information in a format selected from the group including XML and HTML protocols.

24. The method of claim 2 wherein accessing the localization server from a RLE device includes accessing from a RLE device selected from the group including multifunction peripherals (MFPs), consumer entertainment appliances, televisions, television set top boxes, VCRs, DVDs, video games, and kitchen appliances.

25. A system for remotely provisioning text string information, the system comprising:
a localization server having a network-connected port to supply text string information;
at least one remote localization enabled (RLE) device having a network-connected port for accessing the localization server and accepting the transfer of text string information; and,
a RLE-connected user interface screen to display the transferred text string.

26. The system of claim 25 wherein the RLE device selects a first set of text string information, requests the first set of text string information from the localization server, and accepts the transfer of the first set of text string information.

27. The system of claim 26 wherein the RLE device selects a first set of text string information in response to the RLE device being installed in the network, and following the transferring of the first set of text string information, stores the first set of text string information in a RLE device permanent memory.

28. The system of claim 26 wherein the RLE device selects a first set of text string information in response to the RLE device being initialized, and following the transferring of the first set of text string information, reiteratively stores the first set of text string information in a RLE device volatile memory in response to each initialization of the RLE device.

29. The system of claim 26 wherein the RLE-connected user interface has an input to accept user requests; and,
wherein the RLE device selects a first set of text string information in response to a user request, and accepts transfers of text string information from the localization server iteratively, in response to each user-initiated request.

30. The system of claim 26 wherein the RLE-connected user interface has an input to accept user requests; and,
wherein the RLE device selects a first set of text string information in response to a user request, and accepts transfers of a plurality of text strings related to the first set of text string information, and wherein the RLE selects text string information from the plurality of transferred text strings in response to subsequent user-initiated requests.

31. The system of claim 26 wherein the localization server has a memory loaded with a first plurality of text strings in a second plurality of languages; and,
wherein the RLE device accepts text string information in response to selecting a text string language.

32. The method of claim 26 wherein the localization server has a memory loaded with a first plurality of text string in a third plurality of character sets; and,
wherein the RLE device accepts text string information in response to selecting a character set.

33. The system of claim 27 wherein the localization server has a memory loaded with a first plurality of text strings in a second plurality of languages; and,
wherein the RLE device selects a text string language in response to the RLE device installation, accepts transfers of the first plurality of text strings in the selected language, and stores the first plurality of text strings in the selected language in a RLE device permanent memory.

34. The system of claim 28 wherein the localization server has a memory loaded with a first plurality of text strings in a second plurality of languages; and,
wherein the RLE device selects a text string language in response to the RLE device initialization, accepts transfers of the first plurality of text strings in the selected language, and stores the first plurality of text strings in the selected language in a RLE device volatile memory.

35. The system of claim 29 wherein the localization server has a memory loaded with a first plurality of text strings in a second plurality of languages; and,
wherein the RLE device selects a text string in a first language in response to a user-initiated request and accepts transfers of the text string in the first language.

36. The system of claim 30 wherein the localization server has a memory loaded with a first plurality of text strings in a second plurality of languages; and,
wherein the RLE device selects a text string language in a first language in response to a user-initiated request and accepts transfers of a plurality of text strings related to the selected text string in the first language.

37. The system of claim 26 wherein the localization server has a memory loaded with text string information cross-referenced to device manufacturers and model numbers; and,
wherein the RLE device accepts text string information in response to selecting a device manufacturer and model number.

38. The system of claim 26 wherein the localization server has a memory loaded with text string information cross-referenced to accessing clients; and,
wherein the RLE device accepts text string information in response to establishing client identification.

39. The system of claim 26 further comprising:
a master server having a memory loaded with a master set of text string information and a network-connected port to supply text string information;
wherein the localization server has a memory with a partial set of text string information; and,
wherein the RLE device accesses the localization server to determine if the localization server is loaded with the selected text string information, and if the localization server is not loaded with the selected text string information, accesses the master server.

40. The system of claim 26 further comprising:
a network message protocol including an “open connection” message from the RLE device to identify criteria selected from the group including localization server identity, client identification, RLE device manufacturer and model number information, and a security code to authenticate the client identification.

41. The system of claim 26 further comprising:
a network message protocol including a “close connection” message from the RLE device to terminate communications with the localization server.

42. The system of claim 26 further comprising:
a network message protocol including a “connection closed” message from the RLE device to acknowledge the termination of communications with the RLE device.

43. The system of claim 26 further comprising:
a network message protocol including a “retrieve” message from the RLE device to identify criteria selected from the group including text strings, text string languages, and character sets.

44. The system of claim 26 further comprising:
a network message protocol including a “get languages” message from the RLE device to request a list of supported languages.

45. The system of claim 26 further comprising:
a network message protocol including a “get character sets” message from the RLE device to request a list of supported character sets.

46. The system of claim 26 further comprising:
a network message protocol including a “get servers” message from the RLE device to request a list of accessible servers.

47. The system of claim 26 wherein the RLE device accepts transfers of text string information in a format selected from the group including XML and HTML protocols. 48. The system of claim 26 wherein the RLE device is a device selected from the group including multifunction peripherals (MFPs), consumer entertainment appliances, televisions, television set top boxes, VCRs, DVDs, video games, and kitchen appliances.
